(19) United States
(12) Patent Application Publication
(10) Pub. No.: US 2024/0176159 A1
(43) Pub. Date: May 30, 2024

(54) OPTICAL SYSTEM

(71) Applicant: TDK TAIWAN CORP., Taoyuan City (TW)

(72) Inventors: Chia-Che WU, Taoyuan City (TW); Chao-Chang HU, Taoyuan City (TW); Yung-Hsien YEH, Taoyuan City (TW); Chih-Wei WENG, Taoyuan City (TW); Chih-Wen CHIANG, Taoyuan City (TW); Yu-Chiao LO, Taoyuan City (TW); Sin-Jhong SONG, Taoyuan City (TW)

(21) Appl. No.: 18/521,897

(22) Filed: Nov. 28, 2023

Related U.S. Application Data
(60) Provisional application No. 63/428,238, filed on Nov. 28, 2022.

(51) Int. Cl. G02B 27/64; G02B 7/09; G03B 13/36

(52) U.S. Cl. CPC G02B 27/646; G02B 7/09; G03B 13/36

(57) ABSTRACT

An optical system that includes a first module is provided. The first module includes a first movable portion, a first fixed portion, and a first driving assembly. The first movable portion is configured to connect the first optical member, and is movable relative to the first fixed portion. The first driving assembly is configured to drive the first movable portion to move relative to the first fixed portion.

### CROSS REFERENCE TO RELATED APPLICATIONS

This application claims the benefit of U.S. Provisional Application No. 63/428,238, filed Nov. 28, 2022, the entirety of which is incorporated by reference herein.

### BACKGROUND OF THE INVENTION

### Field of the Invention

The application relates in general to an optical system, and in particular, to an optical system configured to take photographs.

### Description of the Related Art

As technology has advanced, a lot of electronic devices (for example, tablet computers and smartphones) have been given the functionality of taking photographs and recording video. These electronic devices have become more commonplace, and have been developed to be more convenient and thin. More and more choices are provided for users to choose from.

### BRIEF SUMMARY OF INVENTION

An embodiment of the invention provides an optical system, including a first module, and the first module includes a first movable portion, a first fixed portion, and a first driving assembly. The first movable portion is configured to connect the first optical member, and is movable relative to the first fixed portion. The first driving assembly is configured to drive the first movable portion to move relative to the first fixed portion.

In some embodiments, the first fixed portion comprises a first opening and a second opening, the first opening and the second opening correspond to a light, wherein the light enters the first module via the first opening along an incident light axis, and when viewed from the incident light axis, the center of the first opening and the center of the second opening do not overlap.

In some embodiments, the first module further comprises a second optical member, and the light enters the second optical member along the incident light axis and moves away from the second optical member along an output light axis, wherein the output light axis is parallel to the incident light axis, and the output light axis and the incident light axis do not overlap.

In some embodiments, the first fixed portion has a plurality of receiving slots formed between the first opening and the second opening, and the first module further comprises a plurality of adhesive members accommodated in the receiving slots and in contact with the first fixed portion and the second optical member.

In some embodiments, the first fixed portion has an inclined surface facing the first optical member, and the second optical member is attached to the inclined surface.

In some embodiments, the moving direction of the light when it leaves the second optical member is opposite to the moving direction of the light when it enters the second optical member.

In some embodiments, the first driving assembly comprises at least one electromagnetic driving member and at least one electromagnetic driving element respectively disposed on the first fixed portion and the first movable portion, wherein the first fixed portion includes a recess formed on a surface of the first fixed portion facing the first optical member, and the electromagnetic driving member is accommodated in the recess.

In some embodiments, the first driving assembly comprises a first electromagnetic driving element, a first electromagnetic driving member, a second electromagnetic driving element, a second electromagnetic driving member. a third electromagnetic driving element, and a third electromagnetic driving member. The first, second, and third driving elements are disposed on the first movable portion. The first, second, and third driving members are disposed on the first fixed portion and respectively correspond to the first, second, and third driving elements. The length of the first electromagnetic driving element is greater than the length of the second electromagnetic driving element.

In some embodiments, the first driving assembly further comprises a controller disposed on the first movable portion, and the third electromagnetic driving element is disposed between the first electromagnetic driving element and the controller. When viewed along the output light axis of the light, the center of the first electromagnetic driving element is disposed between the center of the second electromagnetic driving element and the center of the controller.

In some embodiments, the thickness of the first electromagnetic driving member is greater than the thickness of the second electromagnetic driving member.

In some embodiments, the first module further comprises a second optical member disposed on the first fixed portion, and the second optical member comprises two light path adjusting units and at least one optical unit, the optical unit is disposed between the light path adjusting units.

In some embodiments, the first module further comprises a second optical member disposed on the first fixed portion, and the second optical member comprises a parallelogram cross-section.

In some embodiments, the first module further comprises a second optical member disposed on the first fixed portion, and the second optical member comprises a trapezoidal cross-section.

In some embodiments, the first fixed portion has a T-shaped structure, and the width of the first section of the first fixed portion that is not connected to the first movable portion is less than the width of the second section of the first fixed portion that is connected to the first movable portion.

In some embodiments, the first opening is formed on the upper surface of the first section, and the second opening is formed on the lower surface of the second section. The second opening can be extended from the second section to the first section.

In some embodiments, the first opening is formed on the upper surface of the first section, and the second opening is formed on the upper surface of the second section. The first opening and the second opening can be communicated with each other.

In some embodiments, the optical system further comprises a second module connected to the first section, and the light enters the second module and the first module in sequence.

In some embodiments, the optical system further comprises an optical component disposed beside the second module, and when viewed from the axial direction that is different from the incident light axis, the optical component and the second section overlap.

### BRIEF DESCRIPTION OF DRAWINGS

The invention can be more fully understood by reading the subsequent detailed description and examples with references made to the accompanying drawings, wherein:

FIG. 1 is a schematic diagram of an electronic device with an optical system according to an embodiment of the invention;

FIG. 2 is a schematic diagram of the optical component in the optical system according to an embodiment of the invention;

FIG. 3 is a cross-sectional view taken along the line A-A in FIG. 2;

FIG. 4 is an exploded-view diagram of the first module in the optical component according to an embodiment of the invention;

FIG. 5 is a schematic diagram of some members in the first module according to an embodiment of the invention;

FIG. 6 is a schematic diagram of the optical component according to another embodiment of the invention;

FIG. 7 is a schematic diagram of the optical component according to another embodiment of the invention;

FIG. 8 is a cross-sectional view taken along the line B-B in FIG. 7;

FIG. 9 is an exploded-view diagram of the first module in the optical component according to another embodiment of the invention; and

FIG. 10 is a schematic diagram of some members in the first module according to another embodiment of the invention.

### DETAILED DESCRIPTION OF INVENTION

The making and using of the embodiments of the optical system are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

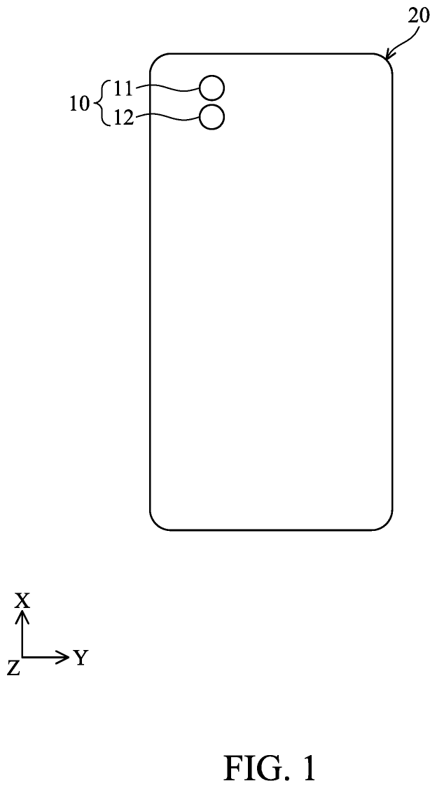

Referring to FIG. 1, the optical system 10 according to an embodiment of the invention can be disposed in an electronic device 20 and used to take photos or record videos. The electronic device 20 can be a smartphone, a tablet computer, or a digital camera, for example, but it is not limited thereto. When taking photos or recording videos, the optical system 10 can receive the light and form an image, wherein the image can be transmitted to a processor (not shown) in the electronic device 20, where post-processing of the image can be performed.

For example, the optical system 10 can include a plurality of optical components 11 and 12 having different focal lengths, and each of the optical components 11 and 12 can form the image independently. Therefore, one of the optical components 11 and 12 can photograph the wide range, and the other one of the optical components 11 and 12 can photograph the far distance. In some embodiments, the optical components 11 and 12 can have same focal length.

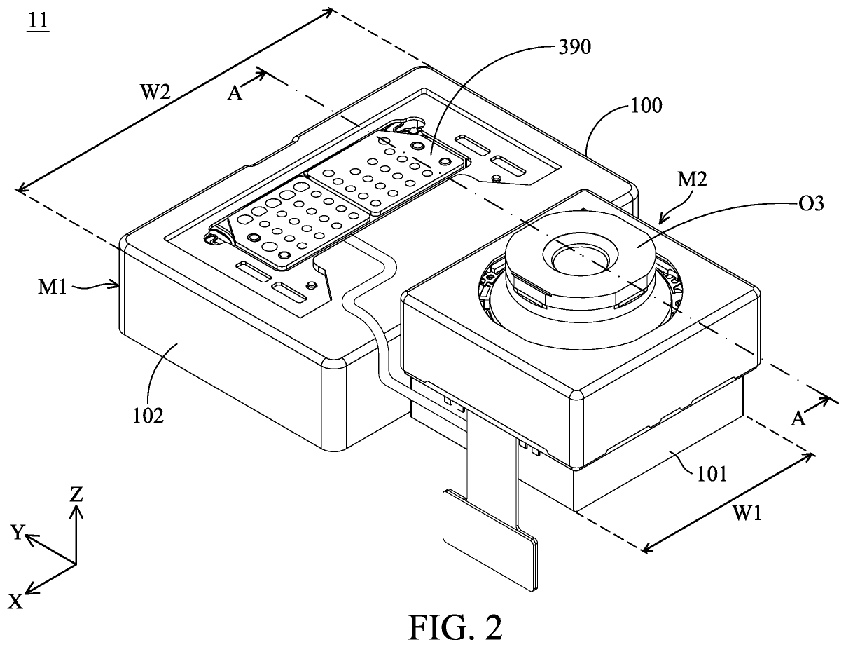

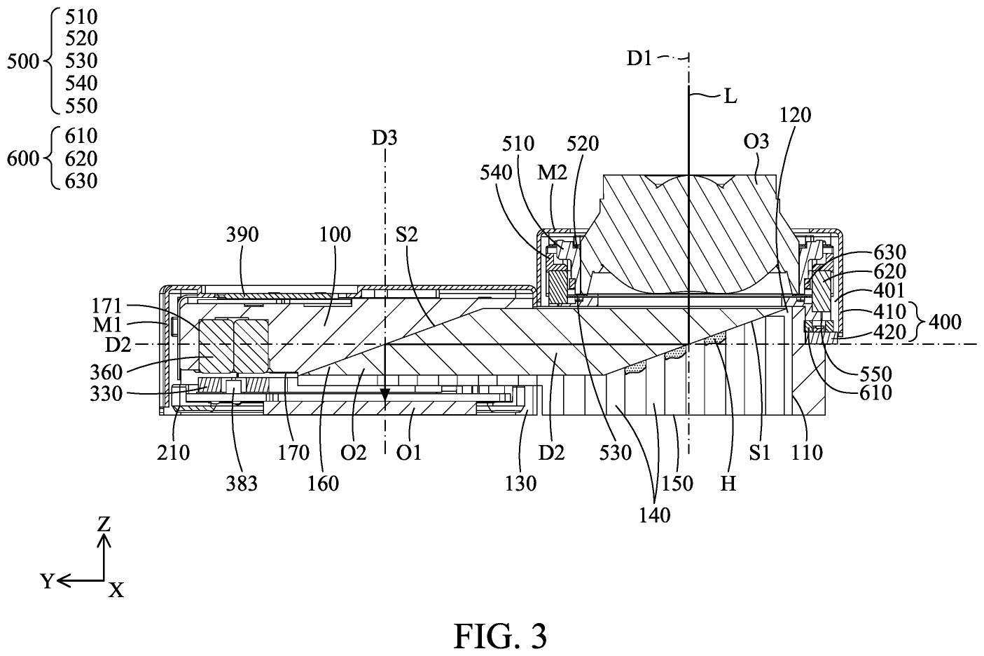

FIG. 2 is a schematic diagram of the optical component 11, and FIG. 3 is a cross-sectional view taken along the line A-A in FIG. 2. As shown in FIG. 2 and FIG. 3, the optical component 11 of the optical system 10 includes a first module M1 and a second module M2. The external light L can pass through a third optical member O3 in the second module M2 along an incident light axis D1, and then enter the second optical member O2 in the first module M1 along the incident light axis D1. The second optical member O2 can adjust the moving direction of the light L. For example, the moving direction of the light L can be firstly adjusted from the incident light axis D1 to the light axis D2, and then the moving direction of the light L can be adjusted from the light axis D2 to an output light axis D3. After that, the light L can move away from the second optical member O2 along the output light axis D3 and reach a first optical member O1 in the first module M1.

The incident light axis D1 is substantially parallel to the output light axis D3, the light axis D2 is not parallel to the incident light axis D1 and the output light axis D3 (for example, the light axis D2 can be perpendicular to the incident light axis D1 and the output light axis D3), and the incident light axis D1 and the output light axis D3 do not overlap with each other. Therefore, when viewed from the incident light axis D1 and/or when viewed from the light axis D2, the third optical member O3 and the first optical member O1 are separated from each other.

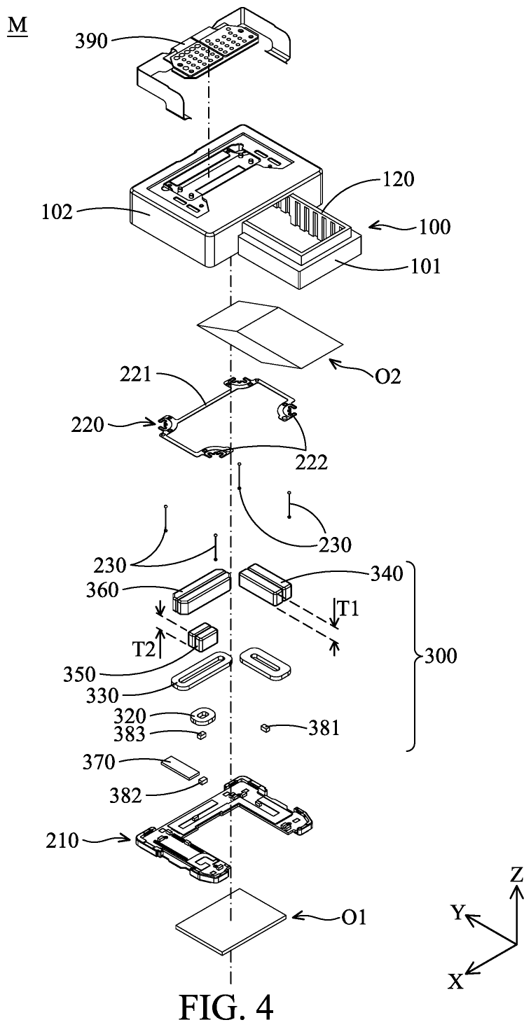

FIG. 4 is an exploded-view diagram of the first module M1 in the optical component 11. As shown in FIG. 2 to FIG. 4, the first module M1 primarily includes a first fixed portion 100, a first movable portion 200, a first driving assembly 300, the first optical member O1, and the second optical member O2. The structures and the arrangements of the aforementioned members are discussed below.

The first fixed portion 100 has a T-shaped structure. A section 101 (first section) of the first fixed portion 100 that is connected to the second module M2 has a width W1, a section 102 (second section) of the first fixed portion 100 that is connected to the first movable portion 200 has a width W2, and the width W1 is less than the width W2. The interior of the first fixed portion 100 has an inner space 110, which is enable to receive the second optical member O2. A first opening 120 can be formed on the upper surface of the section 101, and a second opening 130 can be formed on the lower surface of the section 102. The first opening 120 and the second opening 130 are communicated with the inner space 110. Therefore, the light L can enter the second optical member O2 that is in the inner space 110 via the first opening 120, and leave the second optical member O2 via the second opening 130. In this embodiment, the second opening 130 can be extended from the section 102 to the section 101 to facilitate the assembly of the second optical member O2. When viewed from the incident light axis D1, the center of the second opening 130 is deviated from the center of the first opening 120, so that the center of the first opening 120 and the center of the second opening 130 do not overlap with each other.

The first fixed portion 100 has a plurality of receiving slots 140 formed on the inner surface which surrounds the inner space 110, and the receiving slots 140 is located between the first opening 120 and the second opening 130. When the user wants to affix the second optical member O2 in the inner space 110, an adhesive member H (such as a glue) can be disposed in the receiving slots 140, and the second optical member O2 can be put in the inner space 110 via the second opening 130. The adhesive member H can be in contact with the second optical member O2 and the inner surface of the first fixed portion 100, so that the second optical member O2 can be affixed to the first fixed portion 100. The receiving slots 140 can include an opening 150 that is communicated with an external environment at the position of the second opening 130, so as to facilitate the user to dispose the adhesive member H.

In this embodiment, the second optical member O2 has a parallelogram cross-section, and it has an light path adjusting surfaces S1 and S2 configured to adjust the moving direction of the light L at its opposite sides. The first fixed portion 100 has an inclined surface 160 facing the first optical member O1, and the slope of the inclined surface 160 corresponds to the light path adjusting surface S2 of the second optical member O2. When the user affix the second optical member O2 in the inner space 110, the light path adjusting surface S2 of the second optical member O2 can be attached to the inclined surface 160 by the glue, so as to position the second optical member O2 in a required orientation. The light path adjusting surface S1 can be exposed from the first opening 120, and a gap can be formed between the light path adjusting surface S1 and the first fixed portion 100. For example, the second optical member O2 can include a prism, but it is not limited thereto.

The first movable portion 200 includes a circuit substrate 210, an elastic member 220, and a plurality of supporting members 230. The circuit substrate 210 can be connected to the first fixed portion 100 via the supporting members 230 and the elastic member 220, so that the circuit substrate 210 can be movable or rotatable relative to the first fixed portion 100.

The elastic member 220 includes an inner section 221 and a plurality of outer sections 222. The inner section 221 is affixed to the first fixed portion 100, and each of the outer sections 222 is connected to an end of each of the supporting members 230. The other end of each of the supporting members 230 is connected to the circuit substrate 210. Therefore, the circuit substrate 210 can be movably connected to the first fixed portion 100. The first optical member O1 is affixed to the circuit substrate 210, so that when the circuit substrate 210 moves relative to the fixed portion 100, the first optical member O1 can move accordingly. For example, the first optical member O1 can include an image sensor, and each of the supporting members 230 can be a suspension wire that is elastic.

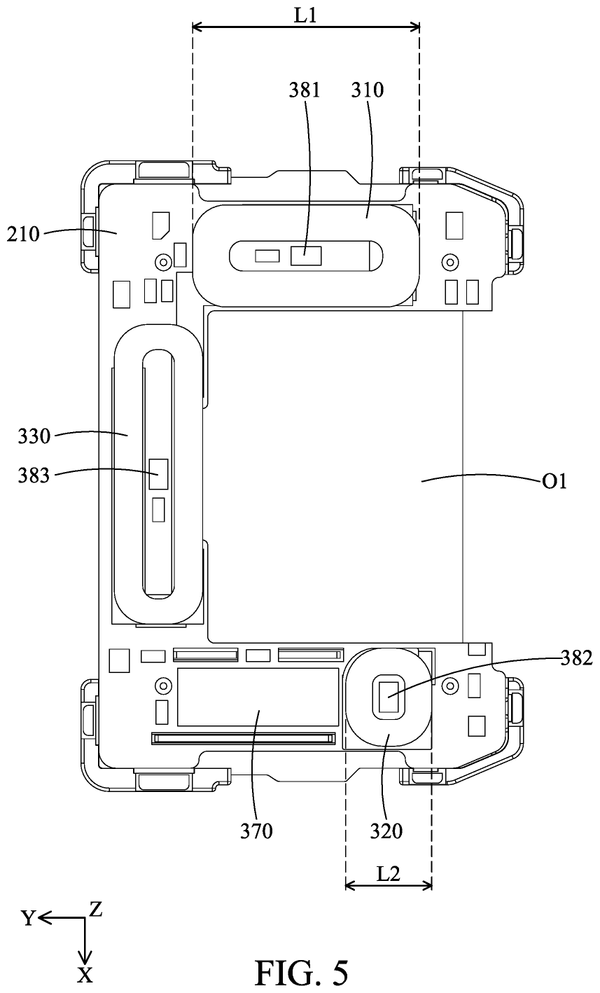

Referring to FIG. 3 to FIG. 5, the first driving assembly 300 includes a first electromagnetic driving element 310, a second electromagnetic driving element 320, a third electromagnetic driving element 330, a first electromagnetic driving member 340, a second electromagnetic driving member 350, a third electromagnetic driving member 360, a controller 370, a plurality of sensing members 381, 382, and 383, and a circuit assembly 390.

The first electromagnetic driving element 310, the second electromagnetic driving element 320, and the third electromagnetic driving element 330 are disposed on the circuit substrate 210, and the third electromagnetic driving element 330 is disposed between the first electromagnetic driving element 310 and the second electromagnetic driving element 320. The first electromagnetic driving member 340, the second electromagnetic driving member 350, and the third electromagnetic driving member 360 are disposed on the first fixed portion 100, and the positions thereof respectively correspond to the positions of the first electromagnetic driving element 310, the second electromagnetic driving element 320, and the third electromagnetic driving element 330.

For example, each of the first electromagnetic driving element 310, the second electromagnetic driving element 320, and the third electromagnetic driving element 330 can be a coil, and each of the first electromagnetic driving member 340, the second electromagnetic driving member 350, and the third electromagnetic driving member 360 can be a magnet. When current flow through the first electromagnetic driving element 310, the electromagnetic effect between the first electromagnetic driving element 310 and the first electromagnetic driving member 340 can provide driving force to push the circuit substrate 210 and the first optical member O1 thereon to move along the X-axis relative to the first fixed portion 100. When current flow through the third electromagnetic driving element 330, the electromagnetic effect between the third electromagnetic driving element 330 and the third electromagnetic driving member 360 can provide driving force to push the circuit substrate 210 and the first optical member O1 thereon to move along the Y-axis relative to the first fixed portion 100. When current flow through the second electromagnetic driving element 320, the electromagnetic effect between the second electromagnetic driving element 320 and the second electromagnetic driving member 320 can provide driving force to push the circuit substrate 210 and the first optical member O1 thereon to rotate relative to the first fixed portion 100. Thus, the purpose of the optical image stabilization (OIS) can be achieved.

In some embodiments, each of the first electromagnetic driving element 310, the second electromagnetic driving element 320, and the third electromagnetic driving element 330 can be a magnet, and each of the first electromagnetic driving member 340, the second electromagnetic driving member 350, and the third electromagnetic driving member 360 can be a coil.

Specifically, the first electromagnetic driving member 340, the second electromagnetic driving member 350, and the third electromagnetic driving member 360 can be accommodated in the recesses 171 that are formed on the surface 170 of the first fixed portion 100 facing the first optical member O1. The whole dimension of the first module M1 can be therefore reduced, and the miniaturization of the optical system 10 can be facilitated. Moreover, since the first, second, and third electromagnetic driving elements 310, 320, and 330 and the first, second and third electromagnetic driving members 340, 350, and 360 are disposed on the same side of the first fixed portion 100, the assembly of the first module M1 can be facilitated.

The controller 370 is disposed on the circuit substrate 210, and can be electrically connected to the first electromagnetic driving element 310, the second electromagnetic driving element 320, and the third electromagnetic driving element 330 to control the movement of the circuit substrate 210. For example, the controller 370 can be a driver IC.

The controller 370 is disposed adjacent to the second electromagnetic driving element 320, so that the third electromagnetic driving element 330 can be disposed between the first electromagnetic driving element 310 and the controller 370. In this embodiment, the thickness T1 of the first electromagnetic driving member 340 in the output light axis D3 is greater than the thickness T2 of the second electromagnetic driving member 350 in the output light axis D3. In the light axis D2, the length L1 of the first electromagnetic driving element 310 is greater than the length L2 of the second electromagnetic driving element 320. The center of the first electromagnetic driving element 310 can be disposed between the center of the second electromagnetic driving element 320 and the center of the controller 370.

The sensing members 381, 382, and 383 can be disposed on the circuit substrate 210, and can be respectively surrounded by the first electromagnetic driving element 310, the second electromagnetic driving element 320, and the third electromagnetic driving element 330. The sensing member 381 can detect the movement of the circuit substrate 210 and the first optical member O1 in the X-axis. The sensing member 383 can detect the movement of the circuit substrate 210 and the first optical member O1 in the Y-axis. The sensing member 382 can detect the rotation angle of the circuit substrate 210 and the first optical member O1 relative to the first fixed portion 100. The sensing members 381, 382, and 383 can be electrically connected to the controller 370, so that they can transmit the obtained data to the controller 370.

For example, each of the sensing members 381, 382, and 383 can be a Hall sensor, a magnetoresistance effect sensor (MR sensor), a giant magnetoresistance effect sensor (GMR sensor), a tunneling magnetoresistance effect sensor (TMR sensor), or a fluxgate sensor, but it is not limited thereto.

The circuit assembly 390 is disposed on the outer surface of the first fixed portion 100. The circuit assembly 390 can penetrate the first fixed portion 100 and enter its internal to electrically connect the first, second, and third electromagnetic driving elements 310, 320, and 330, the controller 370, and/or the sensing members 381, 382, and 383. Moreover, the circuit assembly 390 can be electrically connected to the second module M2 and/or the external circuit in the electronic device 20.

Referring to FIG. 3, the second module M2 includes a second fixed portion 400, a second movable portion 500, a second driving assembly 600, and the third optical member O3.

The second fixed portion 400 includes a case 410 and a base 420. The case 410 and the base 420 can engaged with each other to form an accommodating space 401, and the second movable portion 500 and the second driving assembly 600 can be accommodated in the accommodating space 401. The base 420 is affixed to the section 101 of the first fixed portion 100 to correspond the position of the third optical member O3 to the position of the second optical member O2.

The second movable portion 500 includes a holder 510, an elastic member 520, an elastic member 530, a frame 540, and a plurality of supporting members 550. The holder 510 is configured to hold the third optical member O3. For example, the third optical member O3 can be a camera lens with a plurality of lenses, but it is not limited thereto.

The holder 510 is surrounded by the frame 540, and is connected to the frame 540 by the elastic member 520 and the elastic member 530. In detail, the elastic member 520 is connected to the upper surface of the holder 510 and the upper surface of the frame 540, and the elastic member 530 is connected to the lower surface of the holder 510 and the lower surface of the frame 540. Therefore, the holder 510 can be movably hung in the frame 540.

The supporting members 550 are extended along the incident light axis D1, and the opposite ends of each supporting member 550 are connected to the elastic member 520 and the base 420 respectively. Therefore, the second movable portion 500 can be movably connected to the second fixed portion 400.

The second driving assembly 300 includes at least one electromagnetic driving member 610 disposed on the base 420, at least one electromagnetic driving member 620 disposed on the frame 540, and at least one electromagnetic member 630 disposed on the holder 510. For example, each of the electromagnetic driving member 610 and the electromagnetic driving member 630 can be a coil, and the electromagnetic driving member 620 can be a magnet.

When current flow through the electromagnetic driving member 610, the electromagnetic effect between the electromagnetic driving member 610 and the electromagnetic driving member 620 can provide driving force to push the frame 540 to move relative to the second fixed portion 400 along the X-axis and/or the Y-axis, and the holder 510 and the third optical member O3 disposed thereon can be driven to move along the X-axis and/or the Y-axis accordingly. The purpose of the optical image stabilization can be achieved. When current flow through the electromagnetic driving member 630, the electromagnetic effect between the electromagnetic driving member 630 and the electromagnetic driving member 620 can provide driving force to push the holder 510 and the third optical member O3 disposed thereon to move relative to the frame 540 along the Z-axis. The purpose of zooming and/or focusing can be achieved.

The structure of the optical component 12 is similar to the structure of the second module M2 in the optical component 11, so that the features thereof are not repeated in the interest of brevity. In this embodiment, the optical component 12 can be disposed beside the second module M2. When viewed from the light axis D2, the optical component 12 and the section 102 of the first fixed portion 100 overlap. Thus, the miniaturization of the optical system 10 can be facilitated.

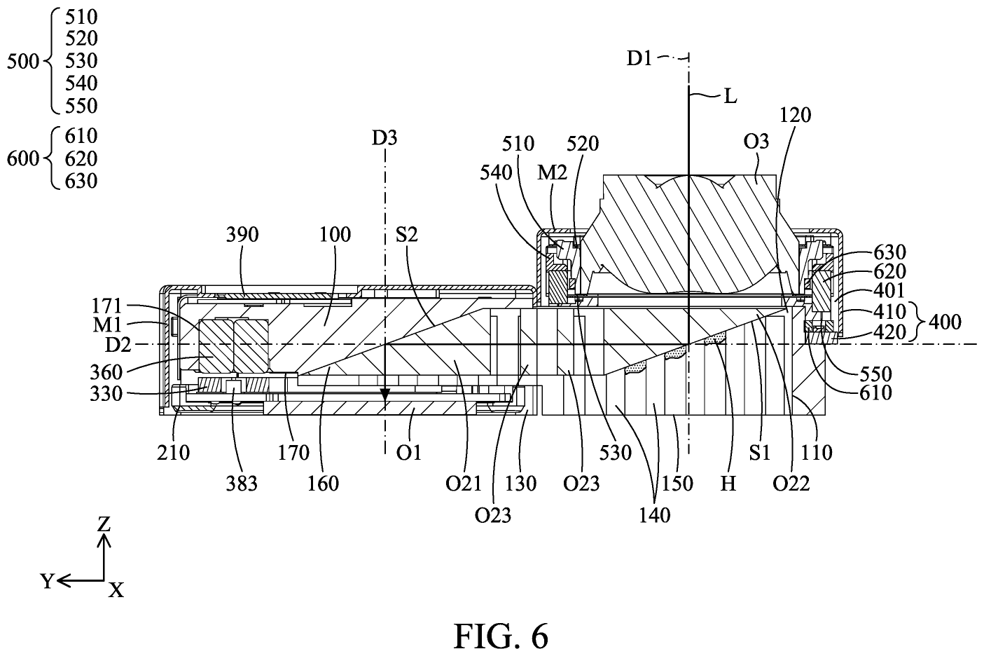

Referring to FIG. 6, in another embodiment of the invention, the second optical member O2 includes two light path adjusting units O21 and O22 and at least one optical unit O23. The optical unit O23 is disposed between two light path adjusting units O21 and O22. Therefore, when the light L passes through the second module M2, it can firstly reach the light path adjusting unit O22, and the light path adjusting unit O22 can adjust the moving direction of the light L to let the light L moving toward the optical unit O23. After the light L passes through the optical unit O23, it can reach the optical pate adjusting unit O21, and the optical pate adjusting unit O21 can adjust the moving direction of the light L to let the light L moving toward the first optical member O1. For example, each of the light path adjusting units O21 and O22 can be a prism or a mirror, and the optical unit O23 can be a lens or a filter, but it is not limited thereto.

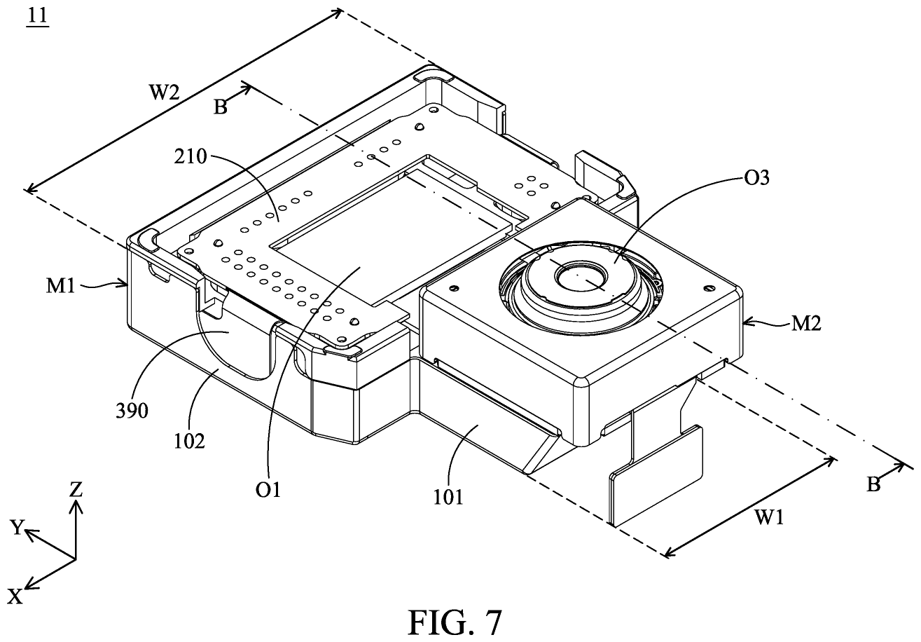

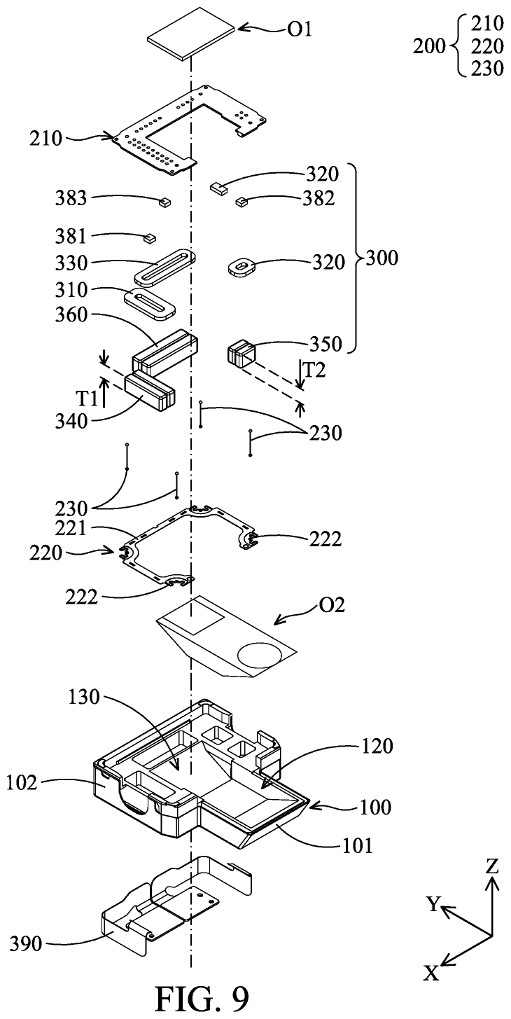

Referring to FIG. 7 to FIG. 9, in another embodiment, the first module M1 of the optical component 11 includes a first fixed portion 100, a first movable portion 200, a first driving assembly 300, the first optical member O1, and the second optical member O2. The first fixed portion 100 has a T-shaped structure. A section 101 of the first fixed portion 100 that is connected to the second module M2 has a width W1, a section 102 of the first fixed portion 100 that is connected to the first movable portion 200 has a width W2, and the width W1 is less than the width W2. The interior of the first fixed portion 100 has an inner space 110, which is enable to receive the second optical member O2. A first opening 120 can be formed on the upper surface of the section 101, and a second opening 130 can be formed on the upper surface of the section 102. The first opening 120 and the second opening 130 are communicated with the inner space 110. Therefore, when the light L passes through the second module M2, it can enter the second optical member O2 that is in the inner space 110 via the first opening 120. Subsequently, the second optical member O2 can adjust the moving direction of the light L, such as adjust the moving direction of the light L from the incident light axis D1 to the light axis D2, and then adjust the moving direction of the light L from the light axis D2 to the output light axis D3 after the light L moves along the axis direction D1 for a while. After that, the light L can leave the second optical member O2 via the second opening 130 along the output light axis D3. In this embodiment, the second optical member O2 has a trapezoidal cross-section. Thus, the moving direction of the light L when it leaves the second optical member O2 can be opposite to the moving direction of the light L when it enters the second optical member O2. When viewed from the incident light axis D1, the center of the first opening 120 and the center of the second opening 130 do not overlap with each other. The first opening 120 and the second opening 130 can be communicated with each other, but it is not limited thereto.

Since the first fixed portion 100 in this embodiment does not need to include the opening on the lower surface, the inner space 110 configured to receive the second optical member O2 can include the appearance corresponding to the appearance of the second optical member O2. Except the surface that the light L entering and leaving, the remaining surfaces of the second optical member O2 can be attached to the first fixed portion 100, so that the second optical member O2 can be steadily affixed. For example, the second optical member O2 can include a prism, but it is not limited thereto.

The first movable portion 200 includes a circuit substrate 210, an elastic member 220, and a plurality of supporting members 230. The circuit substrate 210 can be connected to the first fixed portion 100 via the supporting members 230 and the elastic member 220, so that the circuit substrate 210 can be movable or rotatable relative to the first fixed portion 100.

The elastic member 220 includes an inner section 221 and a plurality of outer sections 222. The inner section 221 is affixed to the first fixed portion 100, and each of the outer sections 222 is connected to an end of each of the supporting members 230. The other end of each of the supporting members 230 is connected to the circuit substrate 210. Therefore, the circuit substrate 210 can be movably connected to the first fixed portion 100. The first optical member O1 is affixed to the circuit substrate 210, so that when the circuit substrate 210 moves relative to the fixed portion 100, the first optical member O1 can move accordingly. For example, the first optical member O1 can include an image sensor.

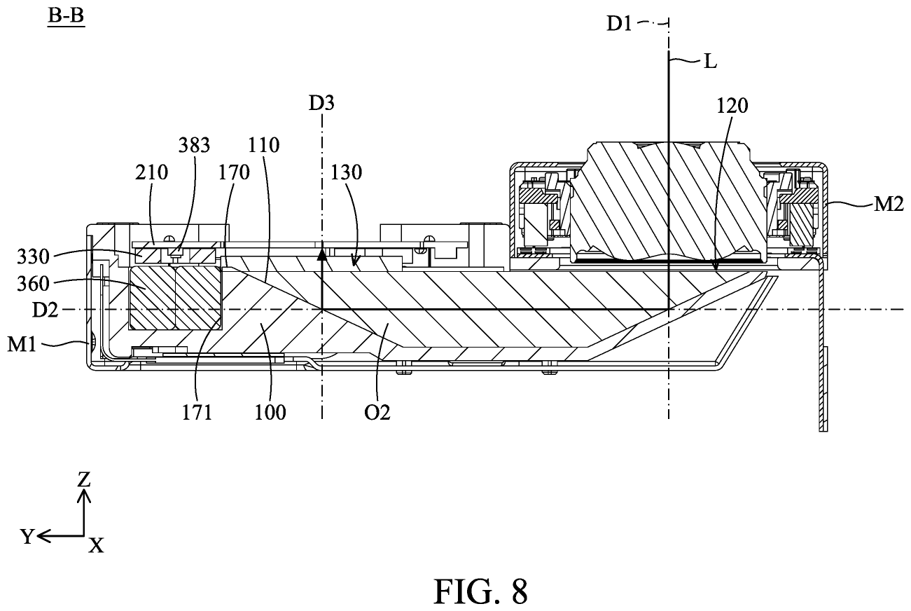

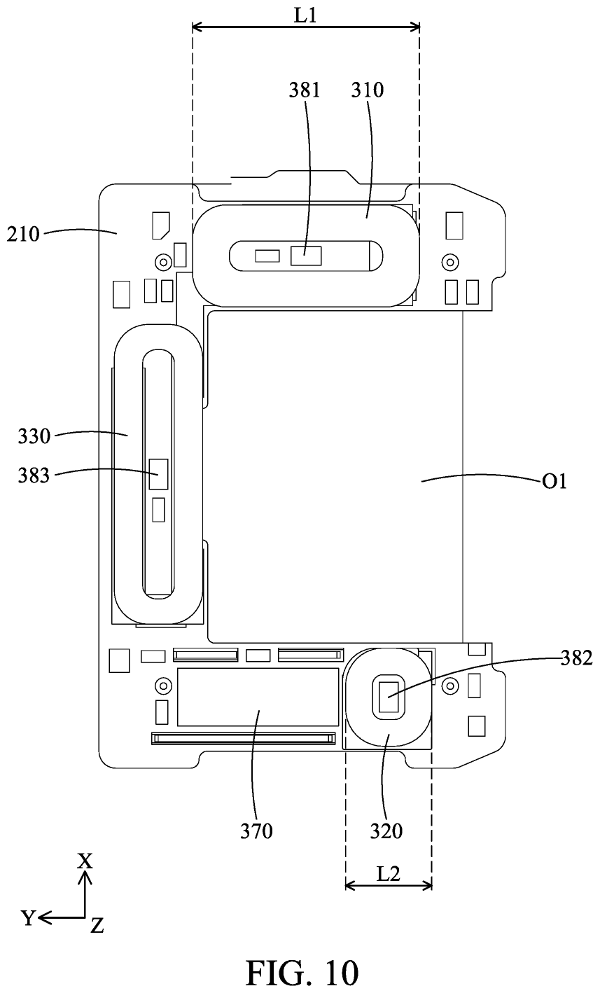

Referring to FIG. 8 to FIG. 10, the first driving assembly 300 includes a first electromagnetic driving element 310, a second electromagnetic driving element 320, a third electromagnetic driving element 330, a first electromagnetic driving member 340, a second electromagnetic driving member 350, a third electromagnetic driving member 360, a controller 370, a plurality of sensing members 381, 382, and 383, and a circuit assembly 390.

The first electromagnetic driving element 310, the second electromagnetic driving element 320, and the third electromagnetic driving element 330 are disposed on the circuit substrate 210, and the third electromagnetic driving element 330 is disposed between the first electromagnetic driving element 310 and the second electromagnetic driving element 320. The first electromagnetic driving member 340, the second electromagnetic driving member 350, and the third electromagnetic driving member 360 are disposed on the first fixed portion 100, and the positions thereof respectively correspond to the positions of the first electromagnetic driving element 310, the second electromagnetic driving element 320, and the third electromagnetic driving element 330.

For example, each of the first electromagnetic driving element 310, the second electromagnetic driving element 320, and the third electromagnetic driving element 330 can be a coil, and each of the first electromagnetic driving member 340, the second electromagnetic driving member 350, and the third electromagnetic driving member 360 can be a magnet. When current flow through the first electromagnetic driving element 310, the electromagnetic effect between the first electromagnetic driving element 310 and the first electromagnetic driving member 340 can provide driving force to push the circuit substrate 210 and the first optical member O1 thereon to move along the X-axis relative to the first fixed portion 100. When current flow through the third electromagnetic driving element 330, the electromagnetic effect between the third electromagnetic driving element 330 and the third electromagnetic driving member 360 can provide driving force to push the circuit substrate 210 and the first optical member O1 thereon to move along the Y-axis relative to the first fixed portion 100. When current flow through the second electromagnetic driving element 320, the electromagnetic effect between the second electromagnetic driving element 320 and the second electromagnetic driving member 320 can provide driving force to push the circuit substrate 210 and the first optical member O1 thereon to rotate relative to the first fixed portion 100. Thus, the purpose of the optical image stabilization can be achieved.

In some embodiments, each of the first electromagnetic driving element 310, the second electromagnetic driving element 320, and the third electromagnetic driving element 330 can be a magnet, and each of the first electromagnetic driving member 340, the second electromagnetic driving member 350, and the third electromagnetic driving member 360 can be a coil.

Specifically, the first electromagnetic driving member 340, the second electromagnetic driving member 350, and the third electromagnetic driving member 360 can be accommodated in the recesses 171 that are formed on the surface 170 of the first fixed portion 100 facing the first optical member O1. The whole dimension of the first module M1 can be therefore reduced, and the miniaturization of the optical system 10 can be facilitated. Moreover, since the first, second, and third electromagnetic driving elements 310, 320, and 330 and the first, second and third electromagnetic driving members 340, 350, and 360 are disposed on the same side of the first fixed portion 100, the assembly of the first module M1 can be facilitated.

The controller 370 is disposed on the circuit substrate 210, and can be electrically connected to the first electromagnetic driving element 310, the second electromagnetic driving element 320, and the third electromagnetic driving element 330 to control the movement of the circuit substrate 210. For example, the controller 370 can be a driver IC.

The controller 370 is disposed adjacent to the second electromagnetic driving element 320, so that the third electromagnetic driving element 330 can be disposed between the first electromagnetic driving element 310 and the controller 370. In this embodiment, the thickness T1 of the first electromagnetic driving member 340 in the output light axis D3 is greater than the thickness T2 of the second electromagnetic driving member 350 in the output light axis D3. In the light axis D2, the length L1 of the first electromagnetic driving element 310 is greater than the length L2 of the second electromagnetic driving element 320. The center of the first electromagnetic driving element 310 can be disposed between the center of the second electromagnetic driving element 320 and the center of the controller 370.

The sensing members 381, 382, and 383 can be disposed on the circuit substrate 210, and can be respectively surrounded by the first electromagnetic driving element 310, the second electromagnetic driving element 320, and the third electromagnetic driving element 330. The sensing member 381 can detect the movement of the circuit substrate 210 and the first optical member O1 in the X-axis. The sensing member 383 can detect the movement of the circuit substrate 210 and the first optical member O1 in the Y-axis. The sensing member 382 can detect the rotation angle of the circuit substrate 210 and the first optical member O1 relative to the first fixed portion 100. The sensing members 381, 382, and 383 can be electrically connected to the controller 370, so that they can transmit the obtained data to the controller 370.

For example, each of the sensing members 381, 382, and 383 can be a Hall sensor, a magnetoresistance effect sensor, a giant magnetoresistance effect sensor, a tunneling magnetoresistance effect sensor, or a fluxgate sensor, but it is not limited thereto.

The circuit assembly 390 is disposed on the outer surface of the first fixed portion 100. The circuit assembly 390 can penetrate the first fixed portion 100 and enter its internal to electrically connect the first, second, and third electromagnetic driving elements 310, 320, and 330, the controller 370, and/or the sensing members 381, 382, and 383. Moreover, the circuit assembly 390 can be electrically connected to the second module M2 and/or the external circuit in the electronic device 20.

The structure of the second module M2 in this embodiment is the same as the structure of the second module M2 in the aforementioned embodiments, so that the features thereof are not repeated in the interest of brevity.

In summary, an embodiment of the invention provides an optical system including a first module, and the first module includes a first movable portion, a first fixed portion, and a first driving assembly. The first movable portion is configured to connect the first optical member, and is movable relative to the first fixed portion. The first driving assembly is configured to drive the first movable portion to move relative to the first fixed portion.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical system, comprising:
a first module, comprising:
a first movable portion, configured to connect the first optical member;
a first fixed portion, wherein the first movable portion is movable relative to the first fixed portion; and
a first driving assembly, configured to drive the first movable portion to move relative to the first fixed portion.

2. The optical system as claimed in claim 1, wherein the first fixed portion comprises a first opening and a second opening, and the first opening and the second opening correspond to a light, wherein the light enters the first module via the first opening along an incident light axis, and when viewed from the incident light axis, a center of the first opening and a center of the second opening do not overlap.

3. The optical system as claimed in claim 2, wherein the first module further comprises a second optical member, and the light enters the second optical member along the incident light axis and moves away from the second optical member along an output light axis, wherein the output light axis is parallel to the incident light axis, and the output light axis and the incident light axis do not overlap.

4. The optical system as claimed in claim 3, wherein the first fixed portion has a plurality of receiving slots formed between the first opening and the second opening, and the first module further comprises a plurality of adhesive members accommodated in the receiving slots and in contact with the first fixed portion and the second optical member.

5. The optical system as claimed in claim 3, wherein the first fixed portion has an inclined surface facing the first optical member, and the second optical member is attached to the inclined surface.

6. The optical system as claimed in claim 3, wherein a moving direction of the light when it leaves the second optical member is opposite to a moving direction of the light when it enters the second optical member.

7. The optical system as claimed in claim 2, wherein the first driving assembly comprises at least one electromagnetic driving member and at least one electromagnetic driving element respectively disposed on the first fixed portion and the first movable portion, wherein the first fixed portion includes a recess formed on a surface of the first fixed portion facing the first optical member, and the electromagnetic driving member is accommodated in the recess.

8. The optical system as claimed in claim 2, wherein the first driving assembly comprises:
a first electromagnetic driving element, disposed on the first movable portion;
a first electromagnetic driving member, disposed on the first fixed portion and corresponding to the first electromagnetic driving element;
a second electromagnetic driving element, disposed on the first movable portion;
a second electromagnetic driving member, disposed on the first fixed portion and corresponding to the second electromagnetic driving element; and
a third electromagnetic driving element, disposed on the first movable portion;
a third electromagnetic driving member, disposed on the first fixed portion and corresponding to the third electromagnetic driving element, wherein a length of the first electromagnetic driving element in a light axis is greater than a length of the second electromagnetic driving element in the light axis, and the light axis is perpendicular to the incident light axis.

9. The optical system as claimed in claim 8, wherein the first driving assembly further comprises a controller disposed on the first movable portion, and the third electromagnetic driving element is disposed between the first electromagnetic driving element and the controller, wherein when viewed from an output light axis of the light, a center of the first electromagnetic driving element is disposed between a center of the second electromagnetic driving element and a center of the controller.

10. The optical system as claimed in claim 8, wherein a thickness of the first electromagnetic driving member in an output light axis is greater than a thickness of the second electromagnetic driving member in the output light axis, and the output light axis is parallel to the incident light axis.

11. The optical system as claimed in claim 2, wherein the first module further comprises a second optical member disposed on the first fixed portion, the second optical member comprises two light path adjusting units and at least one optical unit, and the optical unit is disposed between the light path adjusting units.

12. The optical system as claimed in claim 2, wherein the first module further comprises a second optical member disposed on the first fixed portion, and the second optical member comprises a parallelogram cross-section.

13. The optical system as claimed in claim 2, wherein the first module further comprises a second optical member disposed on the first fixed portion, and the second optical member comprises a trapezoidal cross-section.

14. The optical system as claimed in claim 2, wherein the first fixed portion has a T-shaped structure, and a width of a first section of the first fixed portion that is not connected to the first movable portion is less than a width of a second section of the first fixed portion that is connected to the first movable portion.

15. The optical system as claimed in claim 14, wherein the first opening is formed on an upper surface of the first section, and the second opening is formed on a lower surface of the second section.

16. The optical system as claimed in claim 15, wherein the second opening is extended from the second section to the first section.

17. The optical system as claimed in claim 14, wherein the first opening is formed on an upper surface of the first section, and the second opening is formed on an upper surface of the second section.

18. The optical system as claimed in claim 17, wherein the first opening and the second opening are communicated with each other.

19. The optical system as claimed in claim 14, wherein the optical system further comprises a second module connected to the first section, and the light enters the second module and the first module in sequence.

20. The optical system as claimed in claim 19, wherein the optical system further comprises an optical component disposed beside the second module, and when viewed from an axial direction that is different from the incident light axis, the optical component and the second section overlap.
